(19) United States
(12) Patent Application Publication
(10) Pub. No.: US 2015/0248385 A1
(43) Pub. Date: Sep. 3, 2015

(54) Semantic Network Establishing System and Establishing Method Thereof

(71) Applicant: Jiang Chen, Rowland Heights, CA (US)

(72) Inventor: Jiang Chen, Rowland Heights, CA (US)

(21) Appl. No.: 14/194,804

(22) Filed: Mar. 2, 2014

(51) Int. Cl. G06F 17/24; G06F 3/0484

(52) U.S. Cl. CPC G06F 17/24; G06F 3/0484

(57) ABSTRACT

A semantic network establishing system includes an editing center, a translating center and a node detection center. The editing center generates at least a knowledge node and edits at least a semantic link for encoding a semantic relationship between the knowledge node and the related knowledge node. The translating center communicatively connects the editing center. The translating center acquires an editing content from the knowledge system and sends to the editing center for editing. The node detection center communicatively connects with the knowledge node, wherein the node detection center detects a state of said knowledge node for informing the user the state of the knowledge node, so that the user is encouraged to continuously edit.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to system, and more particular relates to a semantic system, which generates the knowledge node and creates the semantic relationship between the knowledge node and the relate knowledge node in such a manner to establish the semantic network.

2. Description of Related Arts

Knowledge system provides users to collaboratively edit articles for sharing knowledge. Currently, faced with ever expanding amounts of data to process and decreasing budgets, the knowledge system is exploring ways to reduce costs and expand capacity. One avenue of particular interest is the possibility of enabling voluntary community participation in the management process through open data system such as Wikipedia. In a knowledge management system, a large, motivated community is a crucial component. In the large, motivated community, active users and active editors are crucial component. So the manager of the community must seriously consider how to maintain the liveliness of users and editors. Wikipedia is a classic knowledge system and a large, motivated, voluntary community. Recently, the number of the liveliness of users and editors on Wikipedia significantly reduced. The fundamental reason is that all editors on Wikipedia would not gain any reward or honor. Though voluntary editors don't really want reward or honor, but voluntary editors need to gain recognition from users to encourage voluntary editor to edit or update more articles for sharing their knowledge. So that voluntary editors lose their interest in editing or updating articles, the users gain the new knowledge from articles on Wikipedia less and less, and then Wikipedia lose its activity. In other words, Wikipedia cannot provide recognition for voluntary editors from users. More specifically, editors may collaboratively edit an article. For example, the first editor edits several paragraphs of the article on Wikipedia. The second editor amends one paragraph edited by the first editor. The third editor adds several new paragraphs of the article on Wikipedia. But Wikipedia cannot identify paragraph editor, so that Wikipedia cannot give the paragraph editor reward or honor.

Wikipedia is increasingly used as a platform for collaborative data management, but its current technical implementation has significant limitations that hinder its use in various applications, especially in biocuration application. Knowledge management system, such as Wikipedia, utilizes a loose connection to manage the relationship between articles. Specifically, while editors can easily link between two articles in Wikipedia to indicate a relationship, there is no way to indicate the nature of that relationship in a way that is computationally accessible to the system or to external developers. Wikipedia utilizes the hyperlink to establish relationship between articles and to navigate users to visit related articles. In other words, users can visit the related articles through hyperlinks, but users don't know how one article is related to the other articles. For example, editors easily link the article about the 5-HT1A receptor to the article about the biological process of vasodilation through a hyperlink. Through the hyperlink, users just know there is a relationship between the article of 5-HT1A receptor and the article about the biological process of vasodilation, but users don't know how the article of 5-HT1A receptor is related to the article about the biological process of vasodilation. In other words, users may infer the possibility that the 5-HT1A receptor play a role in the process of vasodilation based simply on the presence of hyperlink connecting the two articles. However, such inferences are imprecise. In the worst case the article about the biological process of vasodilation have no context about the 5-HT1A receptor.

A particular weakness of Wikipedia is that it is not designed to support the production of structured data, especially in biocuration activities. For example, one relevant objective might be to produce a list of all the genes related to a given biological process and also to a particular disease. Since there is no query system in Wikipedia, such lists can only be assembled manually-literally by writing them into a ‘list page’ that must be updated by hand. When the relationships between concepts are structured, for example in a database, it becomes trivial to produce such lists through dynamic queries. How to enable the inclusion of structured data in the context of Wikipedia and how to do so without the power to change its technical implementation is a big problem, and currently there is no solution.

### SUMMARY OF THE PRESENT INVENTION

The invention is advantageous in that it provides a semantic network establishing system, which provides an editing center to generate at least a knowledge node and edit a semantic link for encoding semantic relationship between two related knowledge nodes.

Another advantage of the invention to provide a semantic network establishing system, which provides a translating center to translate the semantic link for query the relate knowledge node according to the

Another advantage of the invention is to a semantic network establishing system, which provides an encouragement module to collect a feedback of the knowledge node for informing the corresponding editor, so that the editor is encouraged to continuously edit for maintaining the activity of the knowledge system.

Another advantage of the invention is to provide a semantic network establishing system, which provides a semantic query center for executing queries that utilize said semantic relationships encoded in the semantic links.

Another advantage of the invention is to provide a semantic network establishing system, wherein the translating center provides a content acquisition module for acquiring the editing content from the knowledge system and sending the editing content to the editing center for editing.

Another advantage of the invention is to provide a semantic network establishing system, wherein the translating center provides a plurality of translating module to be selected for translating the semantic link into corresponding format supported by the knowledge system.

Another advantage of the invention is to provide a semantic network establishing system, wherein the editing center provides a semantic editing tool for produce a correctly and formatted the semantic link in the editing center.

Another advantage of the invention is to provide a semantic network establishing system, wherein the editing center provides a presentation module for enhancing the presentation effect of the editing content and eases the semantic link embedded into the editing content through the editing center.

Another advantage of the invention is to provide a semantic network establishing system, wherein the editing center provides a presentation module for generating an infobox displaying all of the semantic links discovered on the current displaying page.

Another advantage of the invention is to provide a semantic network establishing system, which provides a node generator for generator at least a knowledge node according to the editing content edited in the editing center.

Another advantage of the invention is to provide a semantic network establishing system, wherein the knowledge node further comprises a content portion and a property portion, the content portion stores the editing content, and the content stores a plurality of properties regarding said editing content for providing feedback to the encouragement module.

Another advantage of the invention is to provide a semantic network establishing system, wherein the editing center provides a categorizer, which categorizes the knowledge nodes to form at least a knowledge collection.

Another advantage of the invention is to provide a semantic network establishing system, wherein the semantic link comprises an identifier, the translating center selected the translating module according the identifier, and the identifier is capable of being configured for applying to the corresponding knowledge system.

Another advantage of the invention is to provide a semantic network establishing system, wherein encouragement module gives a corresponding independence point to the editor according to the feedback of the knowledge node edited by the user for encouraging the user to continuously edit.

Additional advantages and features of the invention will become apparent from the description which follows, and may be realized by means of the instrumentalities and combinations particular point out in the appended claims.

According to the present invention, the foregoing and other objects and advantages are attained by a semantic network establishing system, comprise: an editing center generating at least a knowledge node and editing at least a semantic link for encoding a semantic relationship between said knowledge node and said related knowledge node, so that a semantic network is established through connecting said knowledge node and said related knowledge node; and

a translating center, said translating center communicatively connecting said editing center, wherein said translating center translates said semantic link for identifying said semantic relationship, so that facilitating to indicate said related knowledge node.

In accordance with another aspect of the invention, the present invention comprises a semantic network establishing method, comprising the steps of:
(A) acquiring an editing content from the knowledge system through an editing center;
(B) editing said semantic link for encoding semantic relationship in said editing content;
(C) generating at least a knowledge node; and
(D) detecting said knowledge node to acquire a state of said knowledge node.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 illustrates a block diagram of the semantic network establishing system according to a preferred embodiment of the present invention.

FIG. 2 illustrates a block diagram of the editing module of the semantic network establishing system according to the preferred embodiment of the present invention.

FIG. 3 illustrates a block diagram of the semantic link of the semantic network establishing system according to the preferred embodiment of the present invention.

FIG. 4 illustrates a schematic diagram of the editing UI of the semantic network establishing system according to the preferred embodiment of the present invention.

FIG. 5 illustrates a schematic diagram of the structure of the relationship type category of the semantic establishing system according to the preferred embodiment of the present invention.

FIG. 6 illustrates a schematic diagram of presentation structure of the link type according to the preferred embodiment of the present invention.

FIG. 7 illustrates a flow chat of establishing semantic network according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

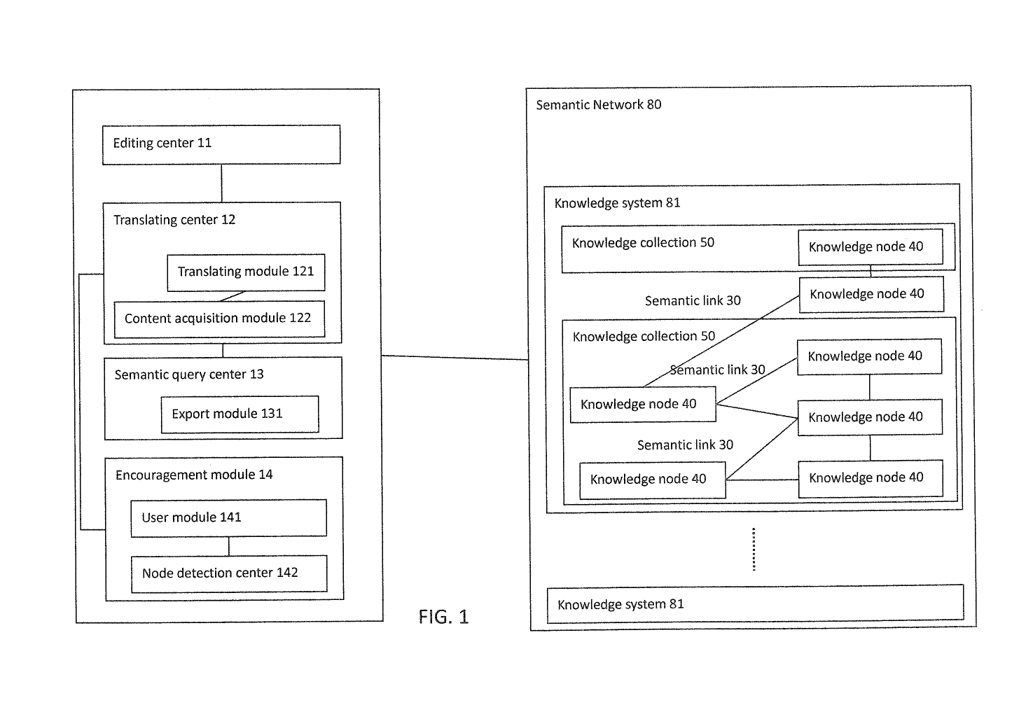

Referring to FIG. 1, a semantic network establishing system of the preferred embodiment of the present invention is illustrated. The semantic network establishing system comprises an editing center 11 and a translating center 12. The editing center 11 communicatively connects with the translating center 12. The editing center 11 provides the editor to edit a semantic relationship. Preferably, the editing center 11 is capable of editing a semantic link 30. The translating center 11 translates the semantic relationship into a standard format supported by the knowledge system provided the editing content, so that the user is capable of using the corresponding knowledge system to visit the edited semantic content. Preferably, the translating center 12 translates the semantic content into the standard HTML, so that the user is capable of using the browser to visit the edited semantic content. The translating center 12 communicatively connects with at least a knowledge system, such as Wikipedia. The translating center 12 acquires the editing content form the knowledge system and sends to the editing center 11 for editing the editing content. The translating center 12 is capable of translating the semantic relationship edited through the editing center 11 into the formant supported by the corresponding knowledge system, so that the corresponding knowledge system supports the semantic relationship. In other words, the translating center 12 is capable of selecting the translating format to be suitable for the knowledge system provided the editing content. The editing content refers to an article, a paragraph of the article, multiple paragraph of the article, a description of a concept, a description of a terminology or a semantic link, and so forth.

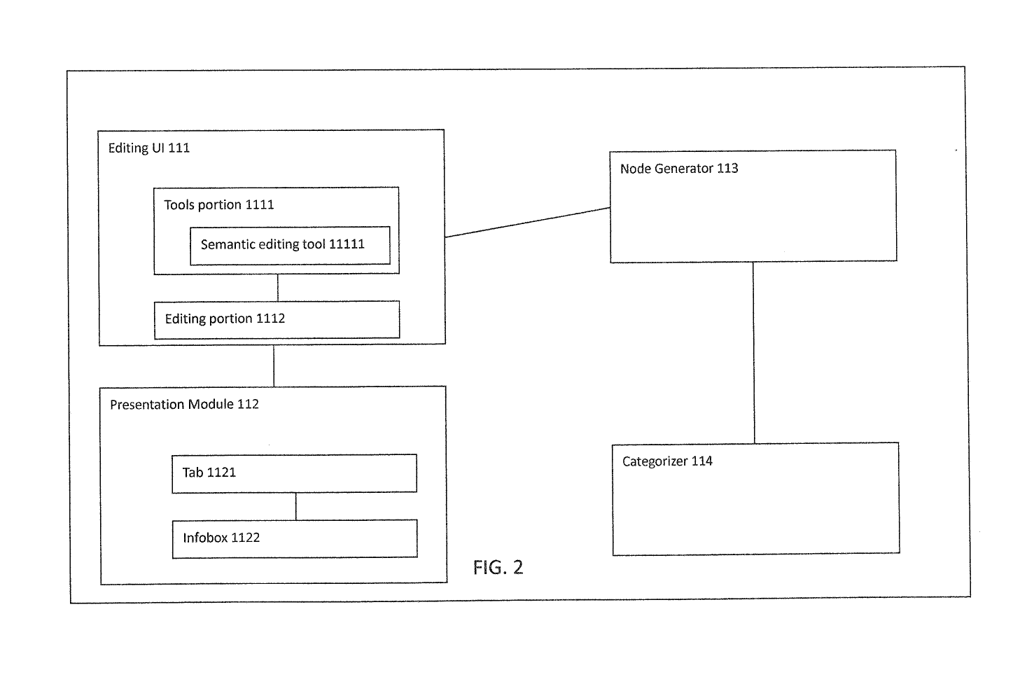

As shown on FIG. 2, the editing center 11 further comprises an editing UI (User Interface) 111 displaying the editing content for editing. The editing center 11 acquires the editing content from the knowledge system and displays the editing center 11 on the editing UI 111. The translating center 12 acquires the editing content form the knowledge system, and sends the editing content to the editing center 11. The editing content is displayed on the editing UI 111. As shown on FIG. 4 the editing UI 111 further comprises a tools portion 1111 and an editing portion 1112. The tools portion 1111 provides a plurality of editing tools for editing the editing content in the editing portion 1112. In the editing portion 1112, a hyperlink is edited for indicating the related content of the knowledge system. It is worth mentioning that the editing portion 1112 is capable of editing a semantic link 30 for encoding the semantic relationship. The semantic link 30 is capable of indicating the semantic type of the relationship between the editing content and the related content.

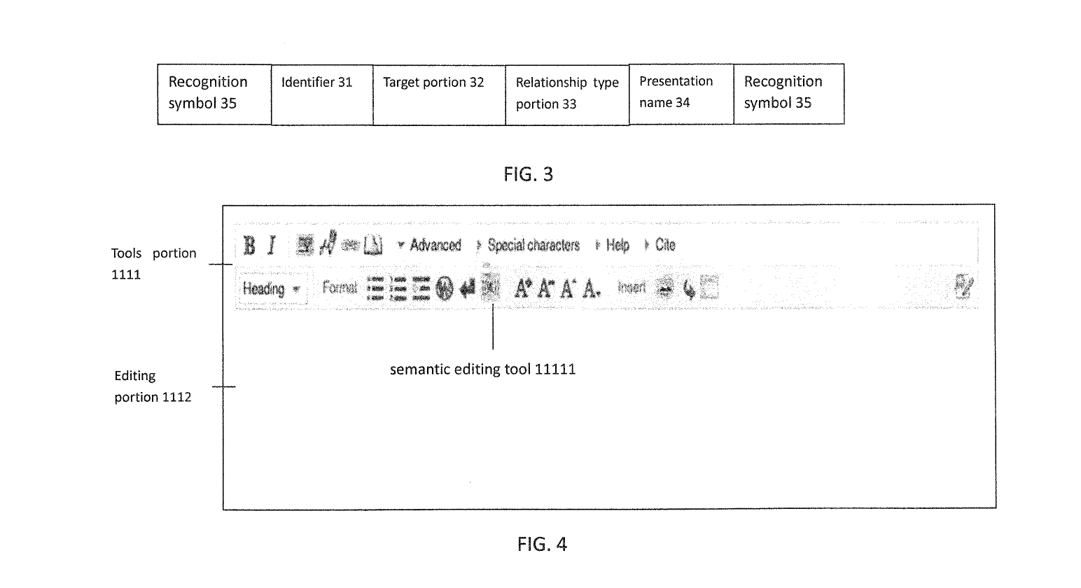

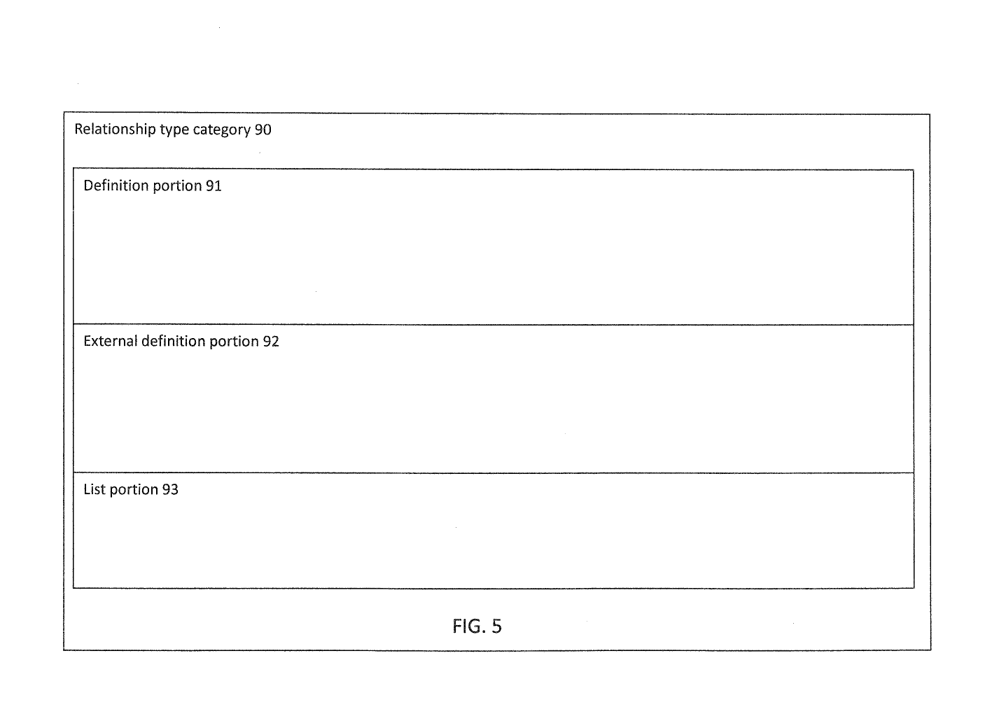

As shown on FIG. 3, the semantic link 30 further comprises an identifier 31, a target portion 32 and a relationship type portion 33. The identifier 31 indicates the type of the semantic link 30 of the knowledge system. The translating center 12 translates the semantic link 30 into the corresponding format supported by the knowledge system according to the identifier 31 of the semantic link 30. The target portion 32 indicates the related content linked by the semantic link 30. The relationship type portion 33 indicates the semantic type of the relationship between the editing content and the related content. The semantic link 30 further comprises a presentation name 34. The presentation name 34 displays the display name for the semantic link 30. Preferably, the presentation name displays on the editing UI 111 or the browser as a label. It is worth mentioning that the presentation name 34 is optional. In other words, the semantic link 30 works normally without the presentation name 34. The semantic link 30 further comprises at least two recognition symbols 35 for recognizing the semantic link 30. The semantic link 30 is enclosed in the recognition symbols 35. Preferably, the recognition symbols are double-braces. It is worth mentioning that the operation on the editing content through the editing center 11 applies to original content in the knowledge system. For example, a paragraph of an article is acquired from Wikipedia, and the semantic link 30 is edited in the paragraph of the article. After the semantic link 30 is translated through the translating center 12, the translated semantic link 30 is embedded into original content in Wikipedia. The translating center 12 translates the editing content containing the semantic link 30 into the format supported by a browser. Preferably, the translating center 12 translates the editing content containing the semantic link 30 into the standard HTML. When the content containing the semantic link 30 is rendered in the knowledge system, the semantic link 30 operates in the same way as other hyperlinks, so the semantic link 30 does not disrupt any existing function in the knowledge system. But the semantic links 30 have consistent structure; it is help to structure the semantic relationship in the knowledge system, so that improves the usage of the knowledge in the knowledge system. Whenever the semantic link 30 is embedded into the editing content of the knowledge system, the editing content containing the semantic link 30 is assigned to a relationship type category 90 of the knowledge system indicating the relationship type according to the relationship type portion 33 of the semantic link 30. A relationship type category 90 is created if the relationship type category 90 does not already exist and adds the relationship type category 90 to the editing content. As shown on FIG. 5, the relationship type category 90. The relationship type category 90 comprises a definition portion 91, the definition portion 91 provides to define the meaning of the relationship. The relationship type category 90 further comprises an external definition portion 92. The external definition portion 92 displays the external definition from external website. The relationship type category 90 further comprises a list portion 93. The list portion 93 provides a list regarding the related relationship type portion 33 of the semantic link 30 in the knowledge system.

As shown on FIG. 4, the editing UI 111 provides a semantic editing tool 11111 to embed the semantic link 30 into the editing content. More specifically, the semantic editing tool is capable of producing the correctly and formatted the semantic link 30. The semantic editing tool 11111 is arranged in the tools portion 1111. The editing center 111 further comprising a presentation module 112, the presentation module 112 is capable of enhancing the presentation effect of the editing content and easing the semantic links 30 embedded the semantic links 30 into the editing content when editing the editing content on the editing center 11. To enhance the presentation effect of the editing content, the presentation module 112 discovers and collects the semantic links 30 on the editing content. It is worth that the presentation module 112 is capable of helping the browser to enhance the presentation effect. In other words, after the presentation module 112 is installed in the browser, the presentation module 112 discovers and collects the semantic links 30 on the displaying page, and then displays all of the semantic links 30 discovered on the displaying page. Preferably, the presentation module 112 generates a tab 1121. When the tab 1121 is clicked, an infobox 1122 is generated through the presentation module 112. The infobox 1122 displays all of the semantic links 30 discovered on the current displaying page on the browser. In order to facilitate to edit the semantic link 30, the editing center 11 provides the semantic link templates.

The editing center 11 further comprises a node generator 113. The node generator 113 generates at least a knowledge node 40 according to the editing content. The knowledge node 40 comprises a property portion 41 and a content portion 42. The property portion 40 records a plurality of node properties, such as the editor information, the creator information, the created time, the edited time, the node views and the original relationship type. The node views refer to the number of the knowledge node 40 is visited by the audiences. Preferably, when the knowledge node is clicked, the property of node views is updated. The original relationship type refers to the relationship type of the knowledge system. The content portion 42 records the editing content. Preferably, the knowledge node 40 is generated after the editing content is saved through the editing center 11. When the user saves the editing content edited through the editing center 11, the editing center 11 generates the knowledge node 40 or updates the knowledge node 40. More specifically, when the user saves the editing content, the editing center 11 detects the editing content whether belongs to the existing knowledge node 40. If the editing content is new creation, then the editing center 11 generates at least one the knowledge node 40. It is worth mentioning that the generating number of the knowledge node 40 is capable of arranging in the editing content through the editing center 11 by the editor. The editing center 11 detects the generating number of the knowledge node 40 and generates the knowledge node 40 corresponding to the generating number of the knowledge node 40. The property portion 41 of the knowledge node 40 stores the editor information and the knowledge node 40 edited time. The content portion 42 stores the editing content. After the knowledge node 40 is generated, the creator information and the created time are stored in the property portion 41. The editing content is stored in the content portion 42. If the editing content belongs to the existing knowledge node 40, the editing center 11 updates the existing knowledge node 40. If a part of the editing content belongs to the existing knowledge node 40, another part of the editing content is new editing, then the existing knowledge node 40 is updated and the new knowledge node 40 is generated according to another part of the editing content. It is worth mentioning that if the editing content includes the semantic link 30, the semantic relationship type of the knowledge node 40 records the relationship type portion 33 of the semantic link 30. If the editing content includes multiple the semantic links 30, then the semantic relationship type records each relationship type portion 33 corresponding to each the semantic link 30. If the editing content doesn't include the semantic link 30, then the semantic relationship type of the knowledge node 40 records nothing, but the relationship type of the knowledge node 40 records the relationship type of the editing content in the knowledge system. The editor is capable of controlling the generation of the knowledge node 40 according to the editing content through the editing center 11. If the editing content is an article, the content portion 42 of the knowledge node 40 may store the entire article. In other words, the editing center 11 generates the single knowledge node 40. If the editing content includes multiple concepts or multiple terminologies, the editing center 11 generates multiple the knowledge nodes 40 according to the single content or the single terminology. The editing center 11 may generate multiple the knowledge nodes 40 according to each paragraph of the editing content. The editing center 11 may generate multiple the knowledge nodes 40 according to each the semantic link 30.

Through the semantic link 30, the knowledge node 40 establishes the semantic relationship with the related knowledge node 40 according to the semantic type of the relationship of the semantic link 30. The knowledge node 40 is capable of containing a plurality of semantic links 30, and then the knowledge node 40 establishes a plurality of the semantic relationships with the related knowledge nodes 40. In such a manner that a semantic web is established. It is worth mentioning that the editing center 11 provides a plurality of semantic template for editing, so that the efficiency of the editing semantic content is improved.

The translating center 12 further comprises a content acquisition module 122. The content acquisition module 122 communicatively connects with the editing UI 111. The content acquisition module 122 communicatively connects to at least a knowledge system, and acquires the editing content from the knowledge system. When the content acquisition module 122 acquires the editing content from the knowledge system, the content acquisition module 122 identifies the type of the knowledge system, and then sends the type of the knowledge system to the editing UI 111. The editing UI 111 selects the corresponding semantic link template according to the type of the knowledge system for editing, so that the efficiency of editing is improved. The content acquisition module 115 is capable of acquiring an article, a paragraph of the article, a concept described in the article or a terminology described in the article. It is worth mentioning that the category of the editing content in the knowledge system is acquired when the editing content acquires the editing content from the knowledge system, so that the editing content is saved, the node generator 113 generates the knowledge node 40, and the category of the editing content in the knowledge system is saved as the original relationship type property of the node knowledge 40. The editing center 11 further comprises a categorizer 114. The categorizer 114 categorizes the knowledge nodes 40 to form at least a knowledge collection 50 according to the original relationship type of the knowledge nodes 40. More specifically, the categorizer 114 acquires the category type of the knowledge nodes 40, and dispatches the knowledge nodes to the corresponding knowledge collection 50. If the knowledge node 40 does not belong to the existing knowledge collection, then the knowledge collection is created through the categorizer 114.

The translating center 12 further comprises a plurality of translating module 121. The translating center 12 identifies the type of the semantic link 30 through the identifier 31 of the semantic link 30. The translating center 12 selects the corresponding translating module 121 to translate the semantic link 30 in the editing content in accordance with the identifier 31 of the semantic link 30 in the editing content. If the editing content has no the semantic link 30. The translating center 12 acquires the type of the knowledge system from the content acquisition module 122. The translating center 12 selects the corresponding translating module 121 for translating the semantic link 30 in the editing content according to the type of the knowledge system. For example, the content acquisition module 122 of the editing center 11 acquires the editing content regarding genes from Wikipedia (a type of the knowledge system), and then sends the Wikipedia that the type of the knowledge system to the editing UI 111 of the editing center 11. The editing UI selects the semantic template corresponding to the editing content of Wikipedia for editing semantic content, such as the semantic link 30. The SWL (Semantic Wiki Link) is utilized as the semantic link 30. The editing UI 111 configures ‘SWL’ as the identifier 31 of the semantic link 30 and configures ‘Gene’ as the relationship type 33. After the editing content is finished editing, the node generator 113 of editing center generates the knowledge node 40. During the generating process of the knowledge node 40, the SWLs in the editing content are translated into the formant supported by the browser. The translating center 12 identifies the identifier 31 of the SWL is ‘SWL’, and then the translating center 12 selects the translating module 121 corresponding to the SWL. The SWL is translated into the format supported by the browser, and then is embedded into the editing content. Preferably, the SWL is translated into standard HTML, and then is embedded into the editing content. After the knowledge node 40 is generated, the categorizer 114 identifies the category type of the knowledge node 40 and categorizes the knowledge node 40 to form the knowledge collection 50. In this case, the knowledge node 40 is categorized to form the gene knowledge collection.

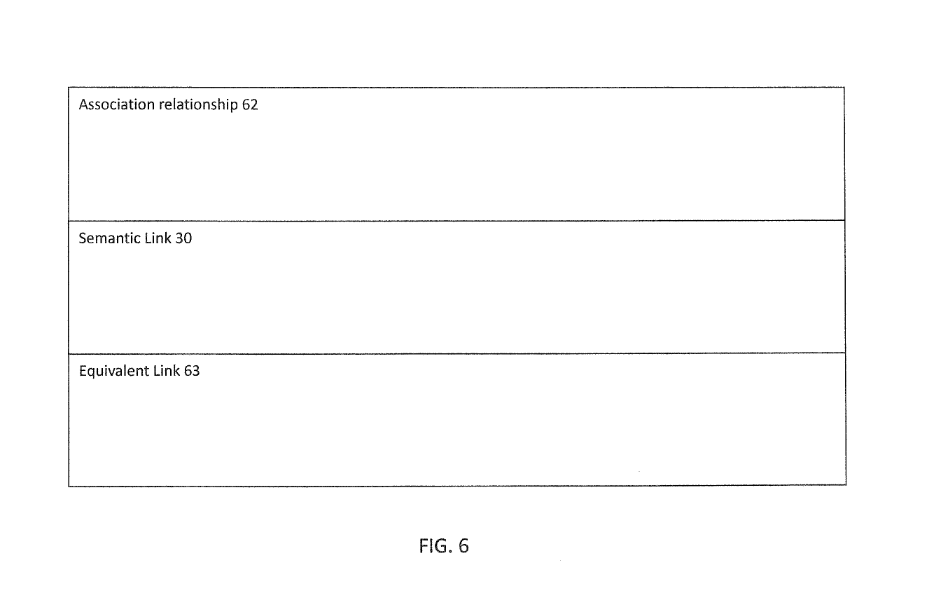

The semantic network management system further comprises a semantic query center 60. The semantic query center 60 communicatively connects with the translating center 12 and at least one knowledge collection 50 separately. The semantic query center 60 enables the users to execute queries that utilize the semantic relationships encoded in the semantic links 30 on the semantic network. Preferably, the semantic query center 60 provides to execute queries that utilize the semantic relationships encoded in the semantic links 30 on the knowledge collections 50, such as the gene knowledge collection. The semantic query center 60 is capable of indentify the semantic relationship from the content portion 42 of the knowledge node 40. The semantic query center 60 detects the semantic link 30 of the editing content stored in the content portion 42 of the knowledge node 40 and converts the semantic link 30 to an equivalent link 63 supported by the semantic query center 60 through the translating center 12. The translating center 12 selected the corresponding translating module 121 to translate the semantic link 30 to the equivalent link. For example, the article on adenosine deaminase of the gene knowledge collection of Wikipedia contains the following semantic link 30 :{{SWL|target=hermolytic anemia|type=overexpression_results_in}}. When the article is transferred to the semantic query center 60, the semantic link 30 is translated to the equivalent link: [[overexpression_ression_in::hemolytic anemia]]. This translation has two consequences in the context of the semantic query center 60. First, the semantic link 30 is visible through the ‘browse properties’ feature when viewing either the adenosine deaminase article or the article on hemolytic anemia. In other words, the corresponding translating module 121 is capable of being configured in the browser for displaying the semantic relationship in the browser. Second, the semantic relationship can be used in the queries such as ‘list all the genes whose over expression results in hemolytic anemia’. These semantic feather are enabled as default behaviors of each the translating module 121 of the translating center 12. To implement the query ‘list all the genes whose over expression results in hemolytic anemia’ by decoupling the encoding of semantic relationships from the query and utilization of those relations. In addition, the semantic relationship type for the semantic link 30 is brought over and encoded as a translating module 121 property. This allows the users of the semantic query center 60 to view the textual definition of the semantic query center 60 and to navigate to related properties with external vocabularies, as shown in FIG. 6. Association relationship 62, Semantic link 30 and equivalent link 63 are displaied in their own displaying area.

It is worth mentioning that the standard hyperlink is translated into a default relationship type through the translating center 12. Preferably, in the knowledge collection 50 of Wikipedia, the default relationship type is configured to an association relationship 62 and represented as ‘is associated with’. For example, the semantic query center 60 executes the query regarding phosphorylation in the gene knowledge collection 50 of Wikipedia. If the content portion 42 of the knowledge node 40 contains a hyperlink linked to the article on phosphorylation, the hyperlink is detected through the semantic query center 60 and translated into [[is_associated_with::phophorylation]] through the translating center 12. Genes that code for kinases, for instance, nearly all include this particular link; translating it to the semantic link 30 allows the users to search for all genes that are associated with phosphorylation. The semantic query can then be expanded to find genes that are involved with phosphorylation and also in cancer, and so forth. These queries will become more powerful as these generic ‘is associated with’ relationships are made more precise.

It is worth mentioning that the default relationship type is capable of forming the root of the property hierarchy used in the semantic query center 60. This means that queries for x where x ‘is_associated_with’ Y will return results where x ‘some more specific relationship’ Y. It is worth mentioning that the semantic links 30 of the editing contents of the knowledge system is edited through the editing center 11, and then the queries in the semantic query center 60 are impacted immediately. But the editing contents brought over from the knowledge system are not editable on the semantic query center 60; any changes are made directly on the original content of the knowledge system. In other words, the semantic query center 60 is the mirroring of the knowledge system.

The semantic query center 60 further comprises an export module 61. The export module 61 extracts a structured content from the semantic query center 60. The structured content is capable of being utilized to perform queries over the encoded relationships and to integrate with the exported data. Preferably, the form of the structured content is a Resource Description Framework (RDF). To facilitate integration with other linked data resource, all editing contents of the semantic query center 60 are annotated with their equivalents in a database 70. The database 70 is a Web-accessible RDF database constructed automatically by extracting data from the consistently structured parts of the editing content of the knowledge system such as categories and ‘infoboxes’. For example, there is a taxonomy infobox that contains data about the scientific classification of organisms (e.g. kingdom, phylum, etc.). Where available, such data is extracted automatically and represented in the DBpedia system. The database 70 makes no attempt to extract data from the hypertext of the editing content of the knowledge system and, as such, is entirely complementary to the data represented in embedded SWLs. Mapping the semantic query center 60 to database 70 provides the opportunity to very easily integrate the information derived from semantic links 30 embedded in editing content with what structured data does exist on Wikipedia. In addition, Database 70 is a central point for ontology term mapping for the Semantic Web and, as a result, integration with it begins the process of integration with the many other knowledge bases that also map their concepts to it.

The semantic query center 60 provides equivalency links between relationship types in the semantic links and properties in external ontologies. Infoboxes display facts as key-value pairs rendered in a table typically visible on the upper right of the editing content of the knowledge system. This is achieved by processing semantic links 30 that appear on relationship type pages in Wikipedia and detecting when they contain the ‘equivalent’ relationship. To use the ‘equivalent’ the relation type portion 33 is configured as ‘equivalent’. For example, the relationship type page for ‘biomarker for’ in Wikipedia contains the SWL: {{SWL|type=equivalent|target=http://}}

In the RDF generated by the semantic query center 60, this is translated to establish an ‘equivalentProperty’ link between the biomarker property of the semantic query center 60 and its equivalent in the external ontologies. Establishing such mappings facilitates the process of integrating RDF-based data assembled at multiple locations—in this case it would help to allow data from the semantic query center 60 to be aggregated with data from the external ontologies.

The semantic network establishing system further comprising a node detection center 70. The node detection center 70 communicatively connects with the knowledge node 40. The node detection center 70 is capable of acquiring the properties and contents of the knowledge node 40. The node detection center 70 processes the properties and contents of the knowledge node 40 and acquires the state of the knowledge node 40. The state of the knowledge node 40 is sent to the user who edited the knowledge node 40 for informing the user the state of the knowledge node 40, so that the editor is encouraged to improve the quality of the knowledge node 40. The node detection center 70 further comprises a user module 71 and a detection module 72. The user module 71 communicatively connects with the detection module 72. The user module 71 stores the user information. The detection module 72 detects the state of the knowledge node 40, and then acquires the user information from the use module 71 for informing the state of the knowledge node 40 edited by the user. It is worth mentioning that if the knowledge node 40 edited by different user at different time, the detection module 72 sends the current state of the knowledge node 40 to each user who edited the knowledge node 40 for encourage them to continuously edit the knowledge node 40. It is worth mentioning that the detection module 72 is capable of sending default amount of independent point to the user according to the state of the knowledge node 40 for encourage the user to continuously edit the knowledge node 40. If the knowledge node 40 edited by multiple users, all of the users receive the independent point sent through the detection module 72. Preferably, the detection module 72 sends the independent point according to the node views property of the knowledge node 40. If the node detection module 72 detects the knowledge node is clicked, the node detection module 72 sends the default amount of the independent point to the user edited the knowledge node. If the content portion 42 of the knowledge node 40 is a paragraph of an article, then the paragraph is clicked, the node detection module 72 sends the default amount of the independent point to the user edited the knowledge node 40. If the content portion 42 of the knowledge node 40 is an article, then the article is clicked, the detection module 72 sends the default amount of the independent point to the user edited the knowledge node 40. If the content portion 42 of the knowledge node 40 is a description of a concept, then the description of the concept is clicked, the detection module 72 sends the default amount of the independent point to the user edited the knowledge node 40. If the content portion 42 of the knowledge node 40 is a semantic link, then the paragraph is clicked, the detection module 72 sends the default amount of the independent point to the user edited the knowledge node 40. In other words, if the knowledge node 40 receives a single action, such as click, slide, the detection module 72 sends the independent point to the user edited the knowledge node 40. It is worth mentioning that the detection module 72 is capable of being preset to detect the state of the knowledge node 40.

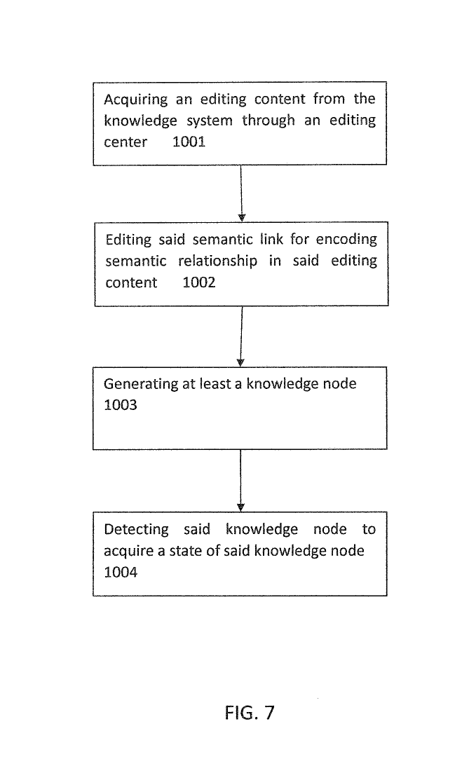

As shown in FIG. 7, a semantic network establishing method comprise the steps of:
Step 1001: acquiring an editing content from the knowledge system through an editing center;
Step 1002: editing the semantic link for encoding semantic relationship in the editing content;
Step 1003: generating at least a knowledge node; and
Step 1004: detecting the knowledge node to acquire a state of the knowledge node.
The step 1004 further comprises the steps of:
(A) acquiring the properties and contents of the knowledge node;
(B) processeing the properties and contents of the knowledge node;
(C) acquiring the state of the knowledge node for informing the user the state of the knowledge, so that the user is encouraged to improve the quality of the knowledge node; and
(D) sending the default amount of the independent point to the user edited the knowledge node according to the state of the knowledge node.
The step (D) may be replace with step (D1): sending the default amount of the independent point to the user edited the knowledge node when receives the single action.
The step 1001 further comprises the steps of:
(A.1) acquiring an editing content from the knowledge system through an editing center;
(A.2) identifying the type of the knowledge system and sending the type of the knowledge system to the editing UI of the editing center; and
(A.3) selecting the corresponding semantic link template according to the type of the knowledge system for the editing UI to edit for improving the efficiency of editing.
The Step 1002 further comprises the steps of:
(B.1) editing the semantic link for encoding semantic relationship in the editing content;
(B.2) translating the semantic link into the corresponding format supported by the knowledge system according to the identifier of the semantic link;
(B.3) embedding the translated semantic link into the corresponding original content in the knowledge system; and
(B.4) assigning the editing content containing the semantic link to a relationship type category, if the relationship type category does not exist then the relationship type category is created and the relationship type category is added to the editing content.
Step (1003) further comprises the steps of
(C.1) generating at least a knowledge node; and
(C.2) establishing the semantic relationship between the knowledge node and the related knowledge node.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A semantic network establishing system, comprising:
an editing center generating at least a knowledge node and editing at least a semantic link for encoding a semantic relationship between said knowledge node and said related knowledge node; and
a translating center, said translating center communicatively connecting said editing center, wherein said translating center for acquiring an editing content from the knowledge system and sending to the editing center for editing.

2. The semantic network establishing system, as recited in claim 1, further comprising a node detection center, said node detection center communicatively connecting with said knowledge node, wherein said node detection center detects a state of said knowledge node for informing the user said state of said knowledge node, so that the user is encouraged to continuously edit.

3. The semantic network establishing system, as recited in claim 2, wherein said node detection center further comprises a user module and a detection module, said user module communicatively connects with said detection module, wherein said detection module sending default amount of independent point to said user according to said state of said knowledge node for encourage said user to continuously edit said knowledge node.

4. The semantic network establishing system, as recited in claim 3, wherein said knowledge node receives a single action, the detection module sends the independent point to the user edited said knowledge node.

5. The semantic network establishing system, as recited in claim 1, further comprising a semantic query center, said semantic query center communicatively connecting with said translating center for executing queries that utilize said semantic relationships encoded in the semantic links on said semantic network.

6. The semantic network establishing system, as recited in claim 4, further comprising a semantic query center, said semantic query center communicatively connecting with said translating center for executing queries that utilize said semantic relationships encoded in the semantic links on said semantic network.

7. The semantic network establishing system, as recited in claim 5, wherein said semantic link further comprises an identifier, wherein said identifier indicates the type of said semantic link of the knowledge system for said translating center 12 translating the semantic link into a corresponding format supported by the knowledge system according to said identifier of the semantic link.

8. The semantic network establishing system, as recited in claim 6, wherein said semantic link further comprises an identifier, wherein said identifier indicates the type of said semantic link of the knowledge system for said translating center 12 translating the semantic link into a corresponding format supported by the knowledge system according to said identifier of the semantic link.

9. The semantic network establishing system, as recited in claim 7, wherein said translating center further comprises a content acquisition module and a plurality of translating module, said content acquisition module identifies a type of the knowledge system for selecting said corresponding translating module to translate said semantic link into a corresponding format supported by the knowledge system, wherein said content acquisition module communicatively connects with at least a knowledge system, said content acquisition module acquires an editing content from the knowledge system and sends said editing content to said editing center for editing said semantic link on said editing content.

10. The semantic network establishing system, as recited in claim 8, wherein said translating center further comprises a content acquisition module and a plurality of translating module, said content acquisition module identifies a type of the knowledge system for selecting said corresponding translating module to translate said semantic link into a corresponding format supported by the knowledge system, wherein said content acquisition module communicatively connects with at least a knowledge system, said content acquisition module acquires an editing content from the knowledge system and sends said editing content to said editing center for editing said semantic link on said editing content.

11. The semantic network establishing system, as recited in claim 9, wherein said editing center further comprises an editing UI communicatively connecting with said translating center, wherein said editing UI editing said editing content acquires from said content acquisition module, wherein said editing provides a semantic editing tool for produce a correctly and formatted said semantic link in said editing UI.

12. The semantic network establishing system, as recited in claim 10, wherein said editing center further comprises an editing UI communicatively connecting with said translating center, wherein said editing UI editing said editing content acquires from said content acquisition module, wherein said editing provides a semantic editing tool for produce a correctly and formatted said semantic link in said editing UI.

13. The semantic network establishing system, as recited in claim 11, wherein said edit center further comprises a presentation module, said presentation module enhances the presentation effect of the editing content and eases said semantic link embedded into the editing content editing through said editing center.

14. The semantic network establishing system, as recited in claim 12, wherein said edit center further comprises a presentation module, said presentation module enhances the presentation effect of the editing content and eases said semantic link embedded into the editing content editing through said editing center.

15. The semantic network establishing system, as recited in claim 13, wherein said presentation module generates an infobox displaying all of the semantic links discovered on the current displaying page.

16. The semantic network establishing system, as recited in claim 17, wherein said presentation module generates an infobox displaying all of the semantic links discovered on the current displaying page.

17. The semantic network establishing system, as recited in claim 15, wherein said editing center further comprises a node generator, said node generator communicatively connects with said editing UI, wherein said node generator generates at least a knowledge node.

18. The semantic network establishing system, as recited in claim 16, wherein said editing center further comprises a node generator, said node generator communicatively connects with said editing UI, wherein said node generator generates at least a knowledge node.

19. The semantic network establishing system, as recited in claim 20, wherein said knowledge node further comprises a content portion and a property portion, wherein said content portion stores said editing content, and said content stores a plurality of properties regarding said editing content.

20. The semantic network establishing system, as recited in claim 18, wherein said knowledge node further comprises a content portion and a property portion, wherein said content portion stores said editing content, and said content stores a plurality of properties regarding said editing content.

21. The semantic network establishing system, as recited in claim 19, wherein said editing center further comprises a categorizer, said categorizer categorizes said knowledge nodes to form at least a knowledge collection.

22. The semantic network establishing system, as recited in claim 20, wherein said editing center further comprises a categorizer, said categorizer categorizes said knowledge nodes to form at least a knowledge collection.

23. The semantic network establishing system, as recited in claim 22, wherein said semantic query center detects said semantic link in the content portion of the knowledge node and coverts said semantic link to an equivalent format supported by said semantic query center through said translating center.

24. The semantic network establishing system, as recited in claim 23, wherein said semantic query center translates the hyperlink into a default relationship type through said translating center.

25. The semantic network establishing system, as recited in claim 28, wherein said semantic query center further comprises an export module extracting a structured content from said semantic query center for integrating with other linked data resource.

26. A semantic network establishing method, comprising the steps of:
(A) acquiring an editing content from the knowledge system through an editing center;
(B) editing said semantic link for encoding semantic relationship in said editing content;
(C) generating at least a knowledge node; and
(D) detecting said knowledge node to acquire a state of said knowledge node.

27. The semantic network establishing method, as recited in claim 26, wherein the step (D) further comprises the steps of:
(D.1) acquiring said properties and contents of said knowledge node;
(D.2) processeing said properties and contents of said knowledge node;
(D.3) acquiring said state of said knowledge node for informing the user the state of the knowledge, so that the user is encouraged to improve the quality of the knowledge node; and
(D.4) sending the default amount of the independent point to the user edited the knowledge node according to said state of said knowledge node.

28. The semantic network establishing method, as recited in claim 26, wherein the step (D) further comprises the steps of:
(D.I) acquiring said properties and contents of said knowledge node;
(D.II) processing said properties and contents of said knowledge node;
(D.III) acquiring said state of said knowledge node for informing the user the state of the knowledge, so that the user is encouraged to improve the quality of the knowledge node; and
(D.IV) sending the default amount of the independent point to the user edited the knowledge node when receives the single action.

29. The semantic network establishing method, as recited in claim 27, wherein the step (A) further comprises the steps of:
(A.1) acquiring an editing content from the knowledge system through an editing center;
(A.2) identifying said type of said knowledge system and sending said type of said knowledge system to said editing UI of said editing center; and
(A.3) selecting said corresponding semantic link template according to said type of said knowledge system for the editing UI to edit for improving the efficiency of editing.

30. The semantic network establishing method, as recited in claim 28, wherein the step (A) further comprises the steps of:
(A.1) acquiring an editing content from the knowledge system through an editing center;
(A.2) identifying said type of said knowledge system and sending said type of said knowledge system to said editing UI of said editing center; and
(A.3) selecting said corresponding semantic link template according to said type of said knowledge system for the editing UI to edit for improving the efficiency of editing.

31. The semantic network establishing method, as recited in claim 29, wherein the step (B) further comprises the steps of:
(B.1) editing said semantic link for encoding semantic relationship in said editing content;
(B.2) translating said semantic link into said corresponding format supported by the knowledge system according to said identifier of said semantic link;
(B.3) embedding said translated semantic link into said corresponding original content in the knowledge system; and
(B.4) assigning said editing content containing said semantic link to a relationship type category, if said relationship type category does not exist then said relationship type category is created and said relationship type category is added to said editing content.

32. The semantic network establishing method, as recited in claim 30, wherein the step (B) further comprises the steps of:
(B.1) editing said semantic link for encoding semantic relationship in said editing content;
(B.2) translating said semantic link into said corresponding format supported by the knowledge system according to said identifier of said semantic link;
(B.3) embedding said translated semantic link into said corresponding original content in the knowledge system; and
(B.4) assigning said editing content containing said semantic link to a relationship type category, if said relationship type category does not exist then said relationship type category is created and said relationship type category is added to said editing content.

33. The semantic network establishing method, as recited in claim 31, wherein the step (C) further comprises the steps of:
(C.1) generating at least a knowledge node; and
(C.2) establishing said semantic relationship between said knowledge node and said related knowledge node.

34. The semantic network establishing method, as recited in claim 32, wherein the step (C) further comprises the steps of:
(C.1) generating at least a knowledge node; and
(C.2) establishing said semantic relationship between said knowledge node and said related knowledge node.
